(19) United States
(12) Patent Application Publication
(10) Pub. No.: US 2014/0363532 A1
(43) Pub. Date: Dec. 11, 2014

(54) Multiple color extrusion type three dimensional printer

(71) Applicant: Kirk W. Wolfgram, Rochester, MN (US)

(72) Inventor: Kirk W. Wolfgram, Rochester, MN (US)

(21) Appl. No.: 13/986,810

(22) Filed: Jun. 10, 2013

(51) Int. Cl. B29C 67/00

(52) U.S. Cl. CPC B29C 67/0085
USPC 425/113

(57) ABSTRACT

The present invention provides an apparatus for manufacturing multiple color three-dimensional (3D) objects using an additive extrusion type manufacturing build process where the multiple color three-dimensional (3D) object is built layer by layer using a single extrusion nozzle in contact or close proximity to each build layer of the 3D object being manufactured.

### FIELD OF INVENTION

The present invention relates to an apparatus for manufacturing multiple color three-dimensional (3D) objects using an additive extrusion type manufacturing build process where the 3D object is built layer by layer. More particularly, the invention relates to the automatic change of material color and use of a single extrusion nozzle in contact or close proximity with each build layer of the 3D object being built.

### BACKGROUND OF THE INVENTION

The use of geometry from three-dimensional (3D) computer aided drafting (CAD) models has been used in conjunction with 3D manufacturing equipment for the purpose of manufacturing prototypes for years. The 3D manufacturing equipment fits into two major categories where the older of two categories involved removal or cutting away of material from a solid block of material such as a CNC machine where the solid block is clamped in place within the CNC machine and material is cut away until the remaining material represents the CAD geometry supplied to the CNC machine. Instead of starting with a volume of material and removing material to create the desired 3D geometry, the newer technology uses an additive process where the 3D CAD model is cut into layers in software and the 3D object is built layer by layer within a build plane until the desired geometry represents the 3D object in the CAD model. The 3D manufacturing equipment (3D Printer) used for this newer technology builds the 3D object by adhering a layer of material to a build plate, then by adhering each consecutive layer to the previous layer in a plane parallel to the build plate within the 3D Printer until the 3D object's geometry matches the 3D CAD geometry provided to the 3D Printer.

While this additive build process for 3D Printing is used by several 3D Printing technologies and 3D printing of multiple color objects is common knowledge, the lowest cost technology involving the Fuse Deposition Modeling (FDM) technology, in particular the extrusion type FDM technology is limited with regards to 3D printing of multiple colored objects. The extrusion type FDM technology manufacturers the 3D object as previously described where the 3D object is built layer upon layer but in this specific niche, the additive build process includes feeding a polymeric build material into a material extruder and moving the material extruder and its extruder nozzle as determined by a controller by means of an x-y-z positioning assembly to build the 3D object. During the first build layer of the 3D object, build material is extruded within the build plane (a plane parallel to the build surface where the extrusion nozzle extrudes build material limited horizontally by the x-y-z positioning assembly's range of motion to move the extrusion nozzle) onto the build plate and more specifically onto the build surface (area specified on the build plate for extruding the first build layer and as determined by the x-y-z positioning assembly's range of motion to move the extruder nozzle). After the build layer is complete, the build plate and build plane are moved one layer apart by the x-y-z positioning assembly as determined by the controller before the next build layer is extruded and adhered the previous build layer. The build process continues layer upon layer until all layers of the 3D object are built within the 3D printers build volume (3D object's maximum part volume as determined by the build plane and as determined by the x-y-z positioning assembly's range of motion to move the build plane relative to the build surface on the build plate). In this first generation of multiple colored 3D printing using this extrusion type FDM technology, the build process stops during each build layer where the color change is required allowing the user to manually change the color of the build material before manually restarting the 3D Printer so it can continue to the next point in the build process where the color change is required.

The second and current generation of multiple color 3D Printers using the extrusion type FDM technology use multiple material extruders fixed relative to each other within the build plane where the plane of extruders and extruder nozzles is controlled by the x-y-z positioning system to move the plane of extruder nozzles relative the build plate and where both extruders pass through the build volume and pass over the build surface simultaneously. When a change to the material color is required, the current material extruder is turned off, the new color material extruder is turned on to continue the build process. While this color change method eliminates the need for the user to manually change material color in each build layer, the use of multiple extruder nozzles within the build plane simultaneously causes some imperfections in the 3D object being printed. Since the non-extruding extruder nozzle(s) is fixed in the build plane with the extruder nozzle in use, the non-extruding extruder nozzle(s) is moved across the surface of each build layer during the build process. While the non-extruding extruder nozzle(s) moves across the build layer, the non-extruding extruder nozzle(s) scraps the build layer picking up and leaving material of a non-desired material color in the 3D object. Thus it would be advantageous to provide a multiple color extrusion type 3D Printer with a means of printing multiple colors where only one extruder nozzle is in the build plane during the build process.

### SUMMARY OF THE INVENTION

In accordance with the present invention there are disclosed several embodiments of a novel Multiple Color Extrusion Type 3D Printer where a build material is extruded onto a build surface (area specified on the build plate for extruding the first build layer and as determined by the x-y-z positioning assembly's range of motion to move the extruder nozzle) to build a 3D Object by means of a single extrusion nozzle located in a build plane (plane parallel to the build surface where the extrusion nozzle extrudes build material limited horizontally by the x-y-z positioning assembly's range of motion to move the extrusion nozzle) during the build process. In the first embodiment, shown are a plurality of material extruders each provided with an extrusion nozzle, each provided with a build material feeder assembly, and each material extruder capable of receiving a given colored build material. All the material extruders and extrusion nozzles are mechanically connected to a x-y-z positioning assembly and moved simultaneously relatively to a build plate. To move each extrusion nozzle in/out of the build plane, this embodiment discloses a material extrusion nozzle positioning assembly capable of moving each extrusion nozzle vertically in and out of the build plane such that only one extrusion nozzle is in the build plane during the build process. When a change is color is required during the build process, the build process is halted and one extruder is turned off, the extrusion nozzle for the color of the build material no longer required is raised out of the build plane, and the extrusion nozzle for the new color build material is lowered into the build plane prior to extruding the new color build material to continue the build process. In the same embodiment an alternate configuration is disclosed showing the x axis of the x-y-z positioning assembly as a means of moving each extrusion nozzle horizontally in and out of the build plane such that only extrusion nozzle is over the build surface and within the build volume during the extrusion process. In this alternate configuration, while the extrusion nozzles are still in the same plane as the build plane, the build plane's horizontal limits as defined by the build volume (3D object's maximum part volume as determined by the build plane and as determined by the x-y-z positioning assembly's range of motion to move the build plane relative to the build surface on the build plate) allows the extrusion nozzles to be moved out of the build plane in a horizontal direction.

In another embodiment there is disclosed a Multiple Color Extrusion Type 3D Printer where multiple build materials are extruded to build a 3D Object by means of a single extrusion nozzle in the build plane. In this embodiment, a material extruder is provided with a single extrusion nozzle and the material extruder is capable of receiving a plurality of different colored build materials, each build material feed into the single material extruder by a build material feeder assembly. The extruder assembly consisting of material extruder, extrusion nozzle, and build material feeder assemblies is moved relative to the build plate by means of a x-y-z positioning assembly. In this embodiment, when a color change is required during the build process, the build material of the color no longer required is stopped from being fed into the material extruder by the build material feeder assembly associated with the color and the new color build material is fed into the material extruder by the build material feeder assembly associated with the new color build material. This embodiment also discloses two or more build materials feed simultaneously into the material extruder such that colors may be blended to provide a new color at the extrusion nozzle different from the colors of the build materials fed into the material extruder.

In another alternate embodiment there is disclosed a Multiple Color Extrusion Type 3D Printer where a docking station is provided to receive a plurality of material extruders each material extruder provided with an extrusion nozzle and each capable of receiving a different colored build material controlled by a build material feeder assembly. In this embodiment, the x-y-z positioning assembly is provided with an extruder clamp capable of receiving a material extruder from the docking station and moving the material extruder with its extrusion nozzle relative to the build plate. In this embodiment, when a color change is required during the build process, the build process is halted while the x-y-z positioning assembly returns the material extruder to the docking station moving the material extruder's extrusion nozzle out of the build plane, then removes the material extruder provided with the new color build material from the docking station before moving the extrusion nozzle associated with the new color into the build plane to continue the build process.

### BRIEF DESCRIPTION OF THE DRAWINGS

FIG. 1 is an isometric view of an existing technology extrusion type 3D Printer with a single material extruder and extruder nozzle.

FIG. 2 is an isometric view of an existing technology extrusion type 3D Printer with dual material extruders and extruder nozzles for the purpose of printing a two color 3D object.

FIG. 3 is an isometric view of a preferred embodiment of a multiple color extrusion type 3D Printer showing a 3D Printer provided with extrusion nozzle positioning assembly to raise and lower (vertical direction) the material extruders and extruder nozzles where the right extruder nozzle is positioned in the build plane.

FIG. 4 is an isometric view of the preferred embodiment shown in FIG. 3 where the left extruder nozzle is positioned in the build plane.

FIG. 5 is an isometric view of the preferred embodiment shown in FIG. 3 where the extrusion nozzles are separated in the x axis direction of adequate distance such that the x axis of the x-y-z positioning assembly also serves as the extruder nozzle positioning assembly by moving the unused extrusion nozzle out of the build plane in a horizontal direction.

FIG. 6 is an isometric view of an alternate embodiment of the invention showing a multiple color extrusion type 3D Printer provided with a material extruder capable of receiving multiple build materials of different colors, and extruding an or all build materials through a single extruder nozzle.

FIG. 7 is an isometric view of another alternate embodiment of the invention showing a multiple color extrusion type 3D Printer provided with a material extruder clamp on the x-y-z positioning assembly, provided with a material extruder docking station, and multiple material extruders where the material extruder clamp is not loaded with a material extruder.

FIG. 8 is an isometric view of the alternate embodiment shown in FIG. 7 where the material extruder clamp is loaded with a material extruder.

### DETAILED DESCRIPTION OF THE INVENTION

It is well known in the three-dimensional fabricating industry that a three-dimensional object can be created by a apparatus using an additive process that builds the three-dimensional object layer by layer onto a build plate per a CAD model and more specifically uses an extrusion type build process as shown by U.S. Pat. No. 8,282,380 issued Oct. 9, 2012 to MakerBot Industries. It is also well know that 3D Slicer software is used to slice a CAD Model into several layers parallel to the build plate and that the extrusion process used to build the 3D Object takes place starting by extruding a layer of build material onto a build plate in a build plane, then moves the build plane and build plate away from each other to build another build layer on the first layer of extruded build material. This process continues layer upon layer each layer moving the build plane and build plate farther from each other while extruding a layer of build material with the same shape as the corresponding CAD Model Slice until the 3D Object being built matches the original CAD model.

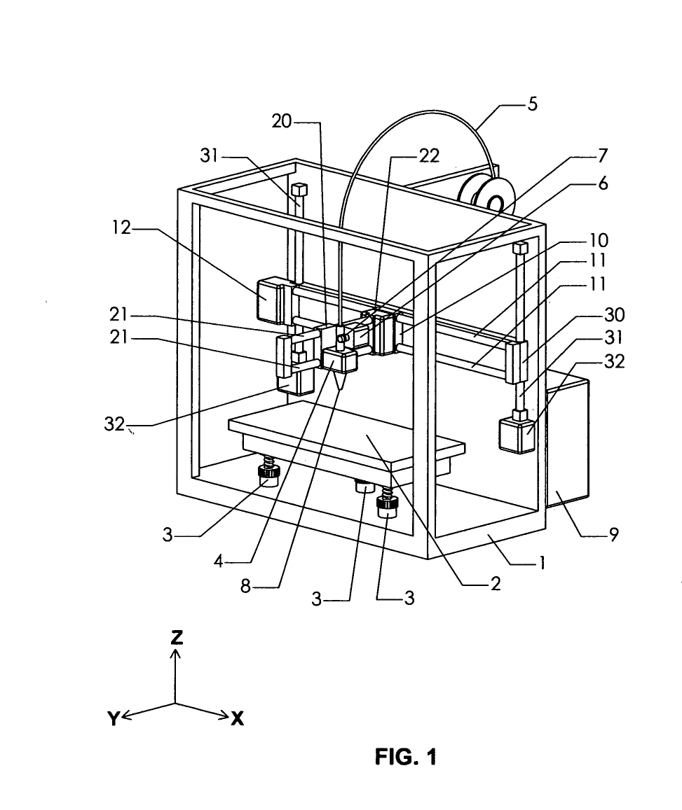

FIG. 1 shows an existing technology three-dimensional (3D) Printer. As shown in FIG. 1, a support structure 1 houses a build plate 2 providing a build surface that is supported by a rigid and stabile leveling assembly 3. While a leveling assembly is typically provided in the existing technology as shown, the leveling of the build plate 2 is not required as the leveling could be compensated for by means of the x-y-z positioning assembly described below. The support structure 1 also houses a material extruder 4 for receiving a build material 5 which is fed into the material extruder 4 by means of a build material Feeder assembly comprised of a stepper motor 6 and build material feed gear 7. The material extruder 4 is also provided with an extrusion nozzle 8 located in the build plane. The stepper motor 6 is electrically connected to a controller 9 to control the feed rate the build material 5 is feed into the material extruder 4 and the material extruder 4 is electrically connected to the controller 9 for the purpose of regulating the temperature of the material extruder 4 such that the build material 5 melts and begins to flow (typically 220° C. to 230° C. for use of ABS as a build material 5) out of the extrusion nozzle 8 as the build material feeder assembly feeds build material 5 into the material extruder 4. The material extruder 4 and extrusion nozzle 8 are mechanically supported by a x-y-z positioning assembly comprised of three linear slides with gear-motor assemblies that are attached to the support structure 1 where the x direction linear slide 10 is supported on rails 11 and moved by a x direction gear-motor 12, where the y direction linear slide 20 is supported on rails 21 and moved by a y direction gear-motor 22, and where the z direction linear slide 30 is supported on rails 31 and moved by a z direction gear-motor 32. The controller 9 is electrically connected is electrically connected each of the x-y-z positioning assembly gear-motors 11, 21, and 31 to position the extruder nozzle 8 relative to the build plate 2.

To build a 3D Object, the controller 9 moves the position of the extrusion nozzle 8 in the build plane parallel to the build plate 2 by means of the x-y-z positioning assembly while controlling the rate build material 5 is feed into the material extruder 4 to extrude a layer of material from the extrusion nozzle 8 onto the build surface in the shape of the CAD model's first slice as determined by the 3D slicer software. After the first build layer is complete, the controller 9 moves the position of the extrusion nozzle 8 to the next build plane away from the build plate 2 by means of the x-y-z positioning assembly to extrude a second layer of material from the extrusion nozzle 8 onto the previous build layer in the shape of the CAD model's next slice as determined by the 3D slicer software. The process continues extruding layer upon layer of material each layer with the shape of the corresponding CAD model slice until the 3D object matches the original geometry of the CAD Model where the thickness of each layer of extruded material is selected by the resolution the user desires as entered into the 3D slicer software. To print a two color 3D object using the 3D printer of FIG. 1, the 3D printer must stop during each layer for user to manually change the color of the build material 5 before restarting the build process.

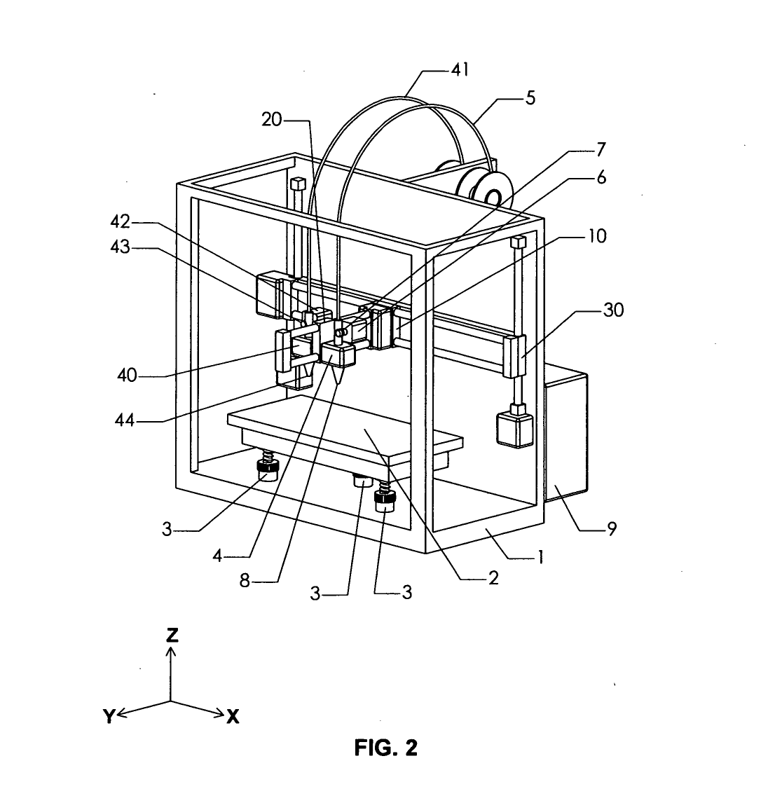

FIG. 2 shows an existing technology two color three-dimensional (3D) printer. The 3D printer shown in FIG. 2 is identical to the 3D printer shown in FIG. 1 except for the addition of a second material extruder 40 for receiving a second build material 41 of a second material color fed into the second material extruder 40 by means of a second build material feeder assembly comprised of a stepper motor 42 and build material feed gear 43, and except for revised logic within the controller 9 to control the second material extruder 40 and to control the second build material feeder assembly. The second material extruder 40 is provided with an extrusion nozzle 44 and is electrically connected to a controller 9 for the purpose of regulating the temperature of the material extruder 40 similarly to the first material extruder 4. The second material extruder 40 and second extrusion nozzle 44 are mechanically supported on the same x-y-z positioning assembly as the first material extruder 4 such that both material extruders extrude into the same build plane. To print a two color 3D object using the 3D printer of FIG. 2, the controller 9 changes colors by stopping the build material being fed into one material extruder and starts the other build material being fed into the other material extruder by stopping and starting the stepper motors 10 and 42. While this technology shown in FIG. 2 eliminates the need for the user to manually change build material from one color to another, the movement of both extruder nozzles simultaneously in the build plane causes the unused extrusion nozzle to touch parts of the 3D object being built (raised imperfections in the build layer) resulting in extruded material being picked up and dragged such that small amounts of the incorrect color material are dropped in undesired areas of the 3D object.

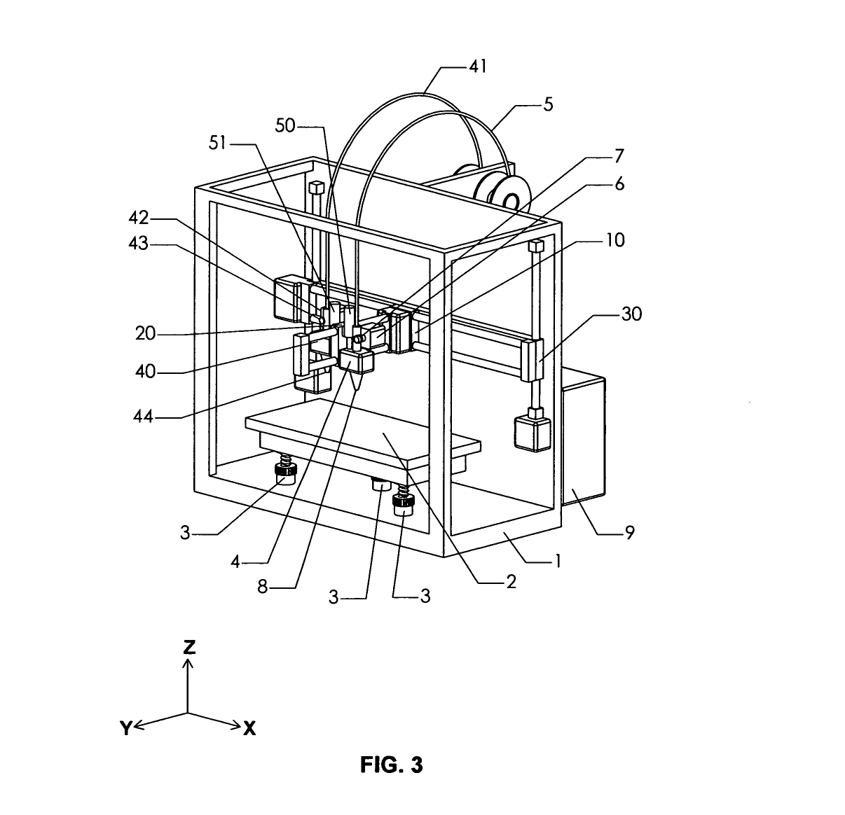

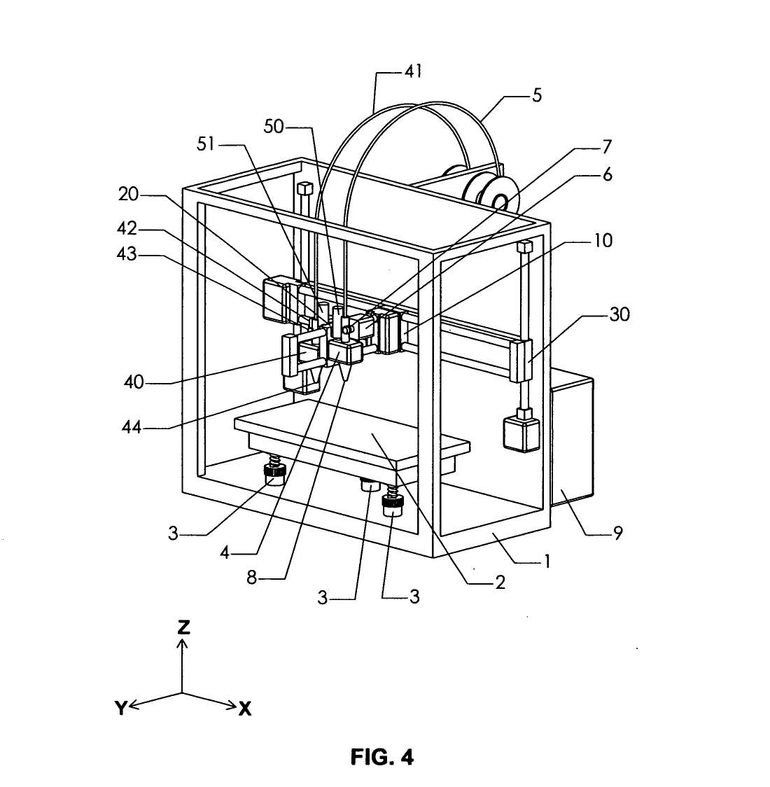

FIG. 3 shows the existing technology two color extrusion type 3D printer of FIG. 2 with a preferred embodiment of the invention showing a extrusion nozzle positioning assembly comprised of two solenoids 50 and 51. The first solenoid 50 is mechanically connected to the material extruder 4 and extruder nozzle 8 and the second solenoid 51 is mechanically connected to the second material extruder 40 and extruder nozzle 44. Both solenoids 50 and 51 are electrically connected to the controller 9 such that the controller 9 can raise and lower each extruder nozzle independent of the other extruder nozzle such that only one extruder nozzle is in the build plane during the build process. To print a two color 3D object using the 3D printer of FIG. 3, the controller 9 changes colors by stopping the first build material 5 being fed into the material extruder 4 and raising the material extruder 4 and extrusion nozzle 8 out of the build plane by means of the solenoid 50, lowering the second material extruder 41 and extrusion nozzle 44 by means of the second solenoid 51 into the build plane as shown in FIG. 4, then feeding second build material 41 of different color into the second material extruder 40 to continue the build process. To change the color of the build materials 5 and 41 back to the first color, the process is reversed stopping and raising the second material extruder 40 along with lowering and starting the first material extruder 4. Since only one extrusion nozzle 4 or 44 is in the build plane while extruding during the build process, and since the other extrusion nozzle is raised above the build plane and does not touch the 3D object being built or any imperfections normally associated with the extrusion process, the 3D object being built does not have random bits of the incorrect colored material scattered throughout the 3D object.

While the two color extrusion type 3D printer shown in FIG. 3 shows two solenoids 50 and 51, it is understood that stepper motors, gear-motors, or any variety of motion control devices and mechanical assemblies could be used to provide the mechanical motion necessary to control the height of the both material extruders and extrusion nozzles relative to the build plane such that only one extrusion nozzle is in the build plane during the build process. While only two material extruders 4 and 40, two build materials 5 and 41, two extrusion nozzles 8 and 44, and two solenoids 50 and 51 are shown, two or more material extruders, build materials, extrusion nozzles and a mechanical motion control system could be provided to limit one extrusion nozzle in the build plane during the build process including a mechanical motion control system that requires only a single motion control device. For example, a gear-motor and a cam could be used to control a plurality of material extruders and extrusion nozzles such that only one extrusion nozzle is in the build plane during the build process. Additionally, a single motion control device could be coupled with the z axis of the x-y-z positioning assembly such that a single solenoid could be used to raise and lower one material extruder and extrusion nozzle above and below a material extruder and extrusion nozzle that is fixed to the x-y-z positioning assembly. In the example, swapping extrusion nozzles in the build plane requires raising or lowering the z axis to move the extrusion nozzle fixed to the x-y-z positioning assembly and lowering or raising (opposite z direction of x-y-z-positioning assembly) twice the distance the z axis moved to position the other extrusion nozzle in or above the build plane.

It is further understood that while a x-y-z positioning assembly is shown to position the extrusion nozzle(s) relative to the build plate 2, a robotic arm commonly used in the motion control industry to move parts within a given three-dimensional space could be used to replace the x-y-z positioning assembly. Additionally, while a variety of motion control devices could be used to raise and lower extrusion nozzles in and out of the build plane, use of one axis of a robotic arm (such as the rotation of a wrist) could be used to raise and lower extrusion nozzles. For example, mechanically connecting one extrusion nozzle to the thumb and connecting a second extrusion nozzle to the little finger would allow rotating of the robotic arm's wrist to raise and lower the extrusion nozzles such that only one extrusion nozzle is in the build plane during the build process.

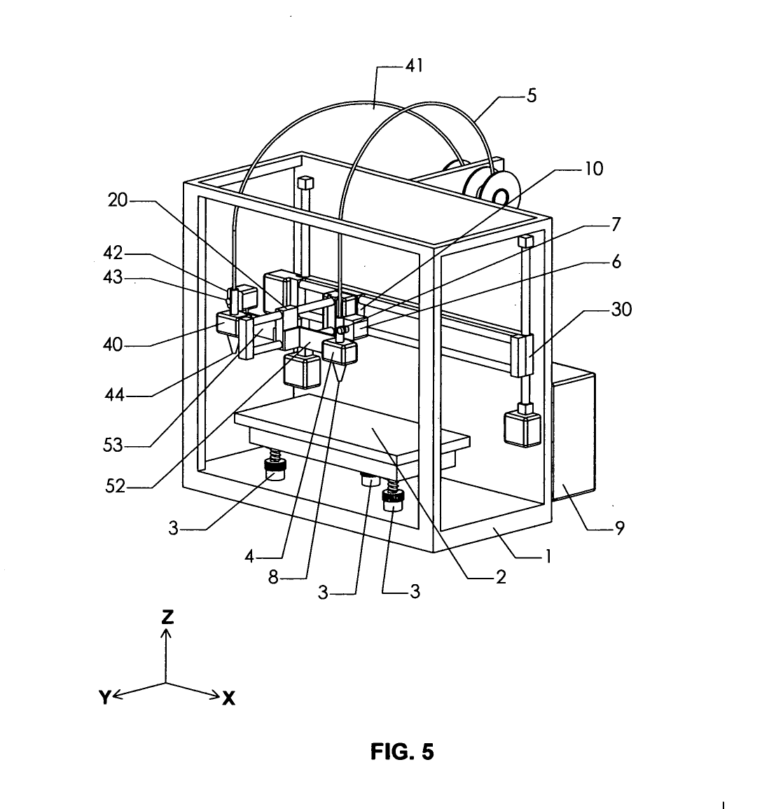

FIG. 5 shows and alternate configuration of the preferred embodiment of FIG. 3 where the extrusion nozzle positioning assembly comprised of solenoids 50 and 51 is replaced with spacers 52 and 53 to provide adequate distance between material extruders 4 and 40 and adequate distance between extrusion nozzles 8 and 44 such that only one extrusion nozzle is in the build plane during the build process. While both extrusion nozzles are in the same plane parallel the build surface, the spacers 52 and 53 provide adequate distance between the extrusion nozzles such that one extrusion nozzle is located horizontally outside the build plane and outside the build volume. In FIG. 5, the x axis of the x-y-z positioning assembly is used to move the extrusion nozzles horizontally in and out of the build plane and the build surface and build volume are limited dimensionally in the direction of the x axis to a maximum distance of the distance provided between the extrusion nozzles 8 and 44. Any distance between the extrusion nozzles 8 and 44 shorter than the length of the build plane or build volume in the same direction would allow both extrusion nozzles 8 and 44 to be in the build plane simultaneously during all or part of the build process resulting in extruded material being picked up and dragged such that small amounts of the incorrect color material are dropped in undesired areas of the 3D object.

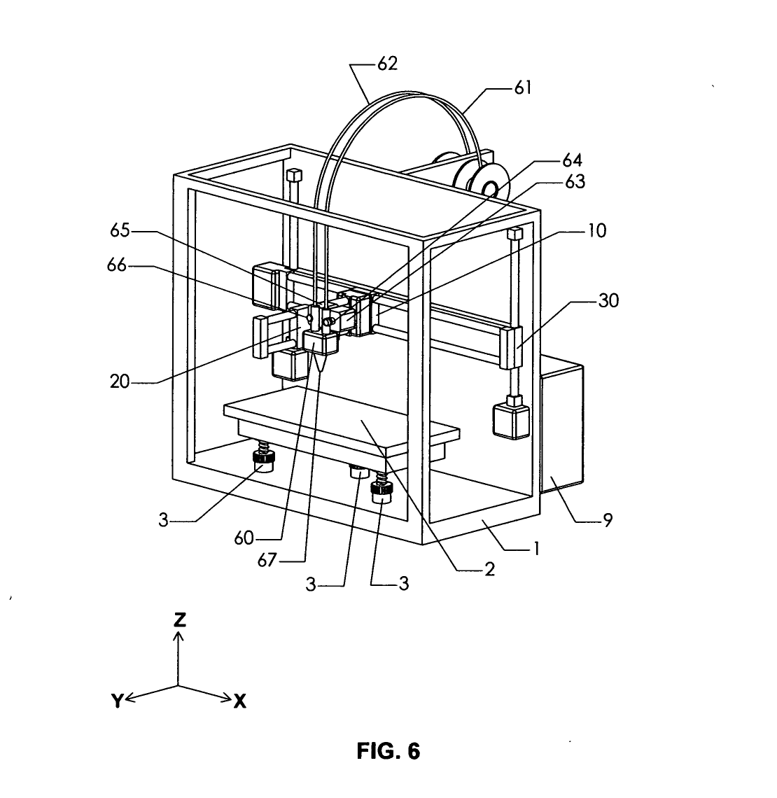

FIG. 6 shows the existing technology two color extrusion type 3D printer of FIG. 1 with a alternate embodiment of the invention showing a single material extruder 60 mechanically connected to the x-y-z positioning assembly. In this embodiment, the material extruder 60 is capable of receiving two different colored build materials 61 and 62. The first build material 61 is fed into the material extruder 60 by means of a build material feeder assembly comprised of a stepper motor 63 and build material feed gear 64. The second build material 62 is fed into the same material extruder 60 by means of a second build material feeder assembly comprised of a second stepper motor 65 and second build material feed gear 66. Both stepper motors 63 and 65 are electrically connected to the controller 9 to control the feed rate each build material 61 and 62 is fed into the material extruder 60. The material extruder 60 is provided with a single extrusion nozzle 67 and the material extruder 60 is electrically connected to the controller 9 for the purpose of regulating the temperature of material extruder 60 such that the build materials 61 an 62 melt and begin to flow out of the single extrusion nozzle 67 as the build material feeder assemblies feed build materials 61 and 62 into the material extruder 60.

In the embodiment shown in FIG. 6, the two build material feeder assemblies can be operated by the controller 9 independently or simultaneously or at different feed rates such that changing the color extruded from the single extrusion nozzle 67 may be changed by stopping the first build material 61 from being fed into the material extruder 60, then starting the second build material 62. The color extruded from the single extrusion nozzle 67 may be changed by starting a second build material 62 feed into the material extruder 60 while the first build material 61 continues to be feed into the material extruder 60 resulting in a blend of the two build materials 61 and 62 being extruded from the single extrusion nozzle 67. The color extruded from the single extrusion nozzle 67 may also be changed by stopping one of the build materials 61 or 62 from being feed into the material extruder 60. The color extruded from the single extrusion nozzle 67 may also be changed by changing the feed rate of the build materials 61 and 62 such that the color extruded from the single extrusion nozzle 67 is a blend of the two build materials 61 and 62 with a mix ratio other than a one to one mixture.

While the two color extrusion type 3D printer shown in FIG. 6 shows two build materials 61 and 62, and two build material feeder assemblies comprised of stepper motors 63 and 65 and build material feed gears 64 and 66, it is understood two or more build materials could be fed into the single material extruder 60 for the purpose of extruding any single build material or a blend of any combination of build materials from the single extrusion nozzle 67 where the single extrusion nozzle 67 is the only extrusion nozzle in the build plane during the build process. Also, while the build material feeder assemblies are shown feeding build materials into the single material extruder 60, material colorants could be provided in place of one or more build materials such that a build material(s) could be combined with any combination of colorant materials in the single extruder 60 and extruded from the single extrusion nozzle 67 as commonly found in plastic molding industry. Additionally, material colorants such as the primary colors (red, blue and green) could be feed into the single material extruder 60 and blended in a multiple combination of mix ratios to extrude multiple colors from the single extrusion nozzle 67.

While a x-y-z positioning assembly is shown in FIG. 6 to position the extrusion nozzle 67 relative to the build plate 2, a robotic arm could be used to replace the x-y-z positioning assembly.

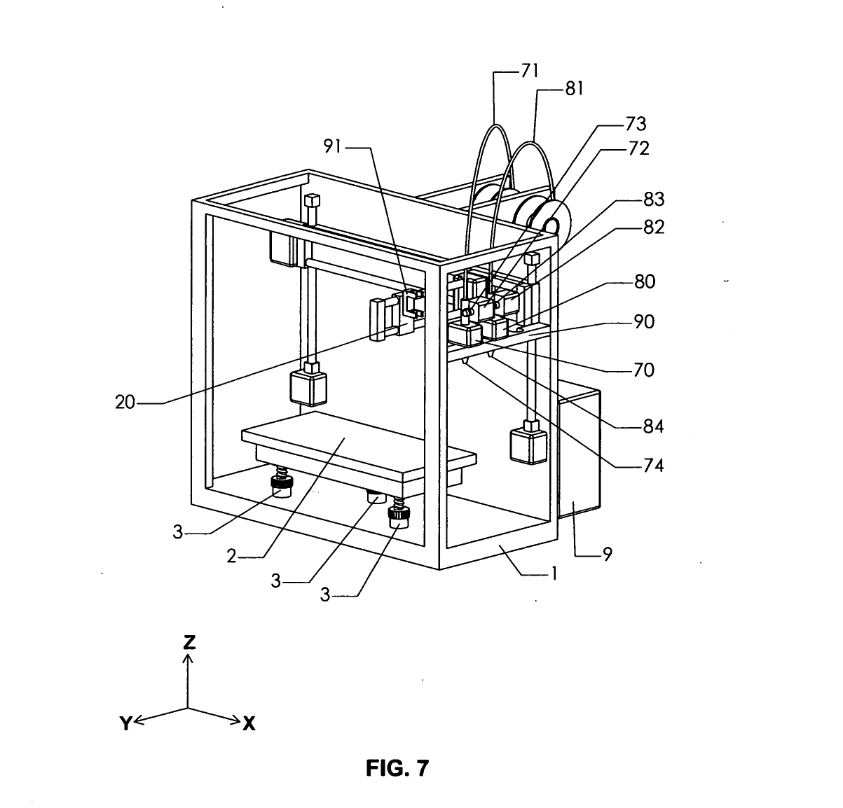

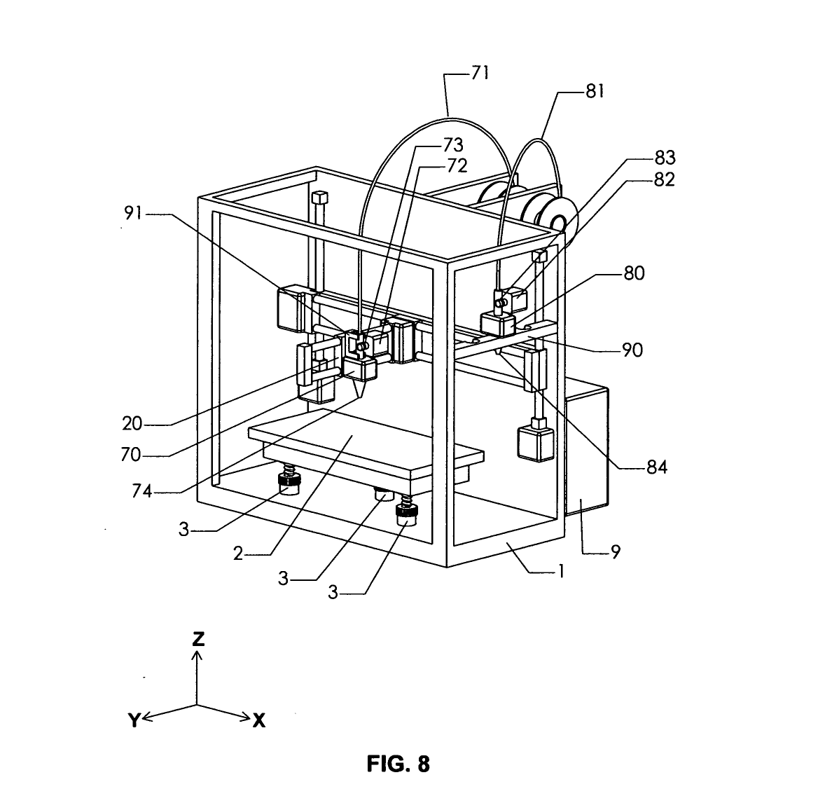

FIG. 7 shows the existing technology two color extrusion type 3D printer of FIG. 2 with a an alternate embodiment of the invention showing a material extruder 70 for receiving a build material 71 feed into the material extruder 70 by means of a build material feeder assembly comprised of a stepper motor 72 and build material feed gear 73 for the purpose of extruding the build material 71 through an extrusion nozzle 74 along with a second material extruder 80 for receiving a second build material 81 of different material color feed into the second material extruder 80 by means of a second build material feeder assembly comprised of a second stepper motor 82 and second build material feed gear 83 for the purpose of extruding the build material 81 through an extrusion nozzle 84. Both stepper motors 73 and 83 are electrically connected to the controller 9 to control the feed rate the building materials 71 and 81 are fed into the material extruders 70 and 80. The material extruders 70 and 80 are electrically connected to the controller 9 to regulate the temperature of the material extruders 70 and 80 such that the build materials 71 and 81 melt and start to flow out of the extrusion nozzles 74 and 84 as the build material feeder assemblies feed build materials 71 and 81 into the material extruders 70 and 80. In this embodiment of the invention, the material extruders 70 and 80 along with the extrusion nozzles 74 and 84 are supported by a docking station 90 but not permanently connected mechanically to the docking station 90. FIG. 7 also shows a extruder clamp 91 mechanically connected to the x-y-z positioning assembly the extruder clamp 91 capable of receiving the material extruders 70 and 80 from the docking station 90. The x-y-z positioning assembly as determined by the controller 9 is capable of moving such that the extruder clamp 91 snaps onto a material extruder 70 or 80 and such that the material extruder 70 or 80 along with the extrusion nozzle 74 or 84 is lifted out of the docking station. As shown in FIG. 8, the material extruder 70 is received by the extruder clamp 91 and removed from the docking station 90. To print a two color 3D object using the printer of FIGS. 6 and 7, the controller 9 changes colors by moving the x-y-z positioning assembly to lower the material extruder and extrusion nozzle into an empty location in the docking station 90, moves the extruder clamp 91 away from the docking station to release the material extruder and extrusion nozzle from the extruder clamp 91, then moves the extruder clamp 91 horizontally to the material extruder and extrusion nozzle fed with the desired color build material to receive the material extruder and extrusion nozzle before lifting the material extruder and extrusion nozzle out of the docking station 91 before continuing the build process. In this embodiment the build surface, build plane, and build volume may be dimensionally limited by the volume the docking station 90 as the 3D object being built cannot be built in the same volume used by the docking station 90. Additionally, the build plane may change dimensionally as the distance between the build plane and build plate change during the build process. In this embodiment involving the docking station 90 and extruder clamp 91, only one extrusion nozzle is in the build plane during the extrusion process while the docking station 91 houses the other material extruder and extrusion nozzle.

While the two color extrusion type 3D printer shown in FIGS. 7 and 8 show two material extruders 70 and 80, two build materials 71 and 81, and two extrusion nozzles 83 and 84, it is understood that two or more material extruders, two or more build materials, and two or more extrusion nozzles may be supported by the docking station 90.

While FIGS. 7 & 8 show a docking station 90 capable of supporting two material extruders 70 and 80, two build materials 71 and 81, and two extrusion nozzles 83 and 84, the 3D printer shown may be modified such that the docking station 90 receives individual build materials instead of the assembly consisting of a material extruder, build material feeder assembly, and extrusion nozzle with build material fed into the material extruder. In this alternate configuration of the embodiment shown in FIGS. 7 and 8, the x-y-z positioning assembly is mechanically connected to a single material extruder, single build material feeder assembly, and connected to a single extrusion nozzle and the color of the material extruded from the extrusion nozzle is changed by the controller 9 moving the x-y-z positioning assembly to park the existing build material in an empty location in the docking station 90, then disconnects the existing build material from the material extruder by backing the existing build material out of the material extruder by reversing the stepper motor in the build material feeder assembly, then repositioning the material extruder in line with the build material of the desired material color before feeding the new build material into the material extruder using the build material feeder assembly connected to the x-y-z positioning assembly. In the same manner, the docking station 90 could be modified to receive any part or all parts of the extrusion equipment described including material extruder, build material, build material feeder assembly, and/or extrusion nozzle such that all parts as shown in FIGS. 7 and 8 are supported by the docking station 90, or the build material and part of the extrusion equipment is supported by the docking station 90, or only the build material is supported by the docking station 90 as previously described.

While a x-y-z positioning assembly is shown in FIGS. 7 and 8 to position the extrusion nozzle 74 or 84 relative to the build plate 2, a robotic arm could be used to replace the x-y-z positioning assembly.

While several preferred embodiments of the present invention have been described, it should be understood that various changes such as but not limited to moving the build plate relative to the extrusion nozzles, various adaptations, and various modifications may be made therein without departing from the spirit of the invention and the scope of the appended claims.

What is claimed is:

1. An apparatus for building multiple colored 3D objects by means of an additive build process comprising:
a support structure;
a build plate providing a build surface for support of a 3D object(s) during said build process;
a material extruder capable of receiving a build material of a given color and capable of extruding said build material through an extrusion nozzle;
a build material feeder assembly capable of varying the rate said build material is feed into said material extruder;
a second material extruder capable of receiving a second build material of a different color than said first material extruder and capable of extruding said second build material through a second extrusion nozzle;
a second build material feeder assembly capable of varying the rate said second build material is feed into said second material extruder;
a x-y-z positioning assembly capable of moving said extrusion nozzles of said material extruders relative to said build plate;
a extrusion nozzle positioning assembly capable of moving said first extrusion nozzle toward and/or away from said build plate relative to said second extrusion nozzle; and
a controller connected to said material extruders, said build material feeder assemblies, said x-y-z positioning assembly, and connected to said material extrusion nozzle positioning assembly.

2. An apparatus of claim 1 where the material extrusion nozzle positioning assembly is capable of moving one extrusion nozzle relative to the x-y-z positioning assembly; and
where said second extrusion nozzle is fixed relative to one axis of said x-y-z positioning assembly.

3. An apparatus of claim 1 where the material extrusion nozzle positioning assembly is capable of moving a first and second extrusion nozzle relative to the x-y-z positioning assembly.

4. An apparatus of claim 1 where the material extrusion nozzle positioning assembly is provided by at least one axis of the x-y-z positioning assembly.

5. An apparatus of claim 1 where the x-y-z positioning assembly is a robotic arm.

6. An apparatus for building multiple colored 3D objects by means of an additive build process comprising:
a support structure;
a build plate providing a build surface for support of a 3D object(s) during said build process;
a material extruder capable of receiving a first build material and capable of receiving a second build material of a different color than said first build material and capable of extruding said build materials through an extrusion nozzle;
a build material feeder assembly capable of varying the rate said first build material is feed into said material extruder;
a second build material feeder assembly capable of varying the rate said second build material is feed into said material extruder;
a x-y-z positioning assembly capable of moving said extrusion nozzle of said material extruder relative to said build plate; and
a controller connected to said material extruders, said build material feeder assemblies, and connected to said x-y-z positioning assembly.

7. An apparatus of claim 6 where said first build material feeder assembly and said second build material feeder assembly feed build materials into said material extruder simultaneously.

8. An apparatus of claim 7 where said first build material feeder assembly and said second build material feeder assembly feed build materials at different feed rates.

9. An apparatus of claim 8 where one build material is a colorant.

10. An apparatus of claim 9 where said build material is a primary color.

11. An apparatus of claim 6 where said material extruder is capable of receiving more than two building materials; and
where a build material feeder assembly is provided to control the rate of each build material independently.

12. An apparatus of claim 11 where at least one build material is a colorant.

13. An apparatus of claim 6 where the x-y-z positioning assembly is a robotic arm.

14. An apparatus for building multiple colored 3D objects by means of an additive build process comprising:
a support structure;
a build plate providing a build surface for support of a 3D object(s) during said build process;
a material extruder capable of receiving a building material of a given color and capable of extruding said build material through an extrusion nozzle;
a building material feeder assembly capable of varying the rate said build material is feed into said material extruder;
a docking station;
a x-y-z positioning assembly capable of moving said extrusion nozzle of said material extruder relative to said build plate; and
a controller connected to said material extruder, said build material feeder assembly, and connected to said x-y-z positioning assembly.

15. An apparatus of claim 14 where said docking station is capable of receiving a plurality of material extruders each material extruder provided with an extruder nozzle and each material extruder capable of receiving a build material.

16. An apparatus of claim 15 where each material extruder is provided with a build material feeder assembly.

17. An apparatus of claim 15 where said x-y-z positioning assembly is provided with a material extruder clamp capable of receiving a material extruder provided with extruder nozzle from said docking station.

18. An apparatus of claim 14 where said docking station is capable of receiving a plurality of build materials.

19. An apparatus of claim 18 where said x-y-z positioning assembly is capable of moving said material extruder to park and to receive build materials from said docking station.

20. An apparatus of claim 14 where the x-y-z positioning assembly is a robotic arm.
